(19) United States
(12) Patent Application Publication
(10) Pub. No.: US 2024/0320048 A1
(43) Pub. Date: Sep. 26, 2024

(54) INFORMATION PROCESSING METHOD AND AN APPARATUS

(71) Applicant: Beijing Zitiao Network Technology Co., Ltd., Beijing (CN)

(72) Inventor: Xin TAO, Beijing (CN)

(21) Appl. No.: 18/612,529

(22) Filed: Mar. 21, 2024

(30) Foreign Application Priority Data
Mar. 21, 2023 (CN) 202310282771.3

(51) Int. Cl. G06F 9/50

(52) U.S. Cl. CPC G06F 9/5027

(57) ABSTRACT

The present application discloses an information processing method which can be applied to an integration platform. The integration platform can receive a resource viewing operation triggered in the integration platform, the resource viewing operation is used to view information of a proxy service, and business data between the integration platform and a device on which the proxy service is installed are transmitted through the proxy service. After the resource viewing operation is received, a resource topology can be displayed in response to the resource viewing operation, and the resource topology is used to indicate an association relationship between at least one proxy service and at least one device. Thus, it can be seen, by using this scheme, users can view the resource topology after triggering the resource viewing operation, so as to obtain the association relationship between the proxy service and the device.

### CROSS REFERENCE TO RELATED APPLICATION

Under the applicable patent law and/or rules pursuant to the Paris Convention, this application is made to timely claim the priority to and benefits of Chinese Patent Application No. 202310282771.3, filed on Mar. 21, 2023. For all purposes under the U.S. law, the entire disclosure of the aforementioned applications is incorporated by reference as part of the disclosure of this application.

### TECHNICAL FIELD

The present application relates to the field of computer technology, in particular to an information processing method and an apparatus.

### BACKGROUND

User can access data from other device(s) through an integration platform. In a specific example, a proxy service can be installed on a device, the proxy service is used to act as an intermediary for interaction between the integration platform and the device, enabling access to data from the aforementioned other device(s) through the integration platform.

How to efficiently manage the proxy service installed on the device is an unsolved problem at present.

### SUMMARY

In order to solve or at least partially solve the above problems, the embodiment of the present application provides an information processing method and an apparatus.

In a first aspect, an embodiment of the present application provides an information processing method which is applied to an integration platform, comprising:

receiving a resource viewing operation triggered in the integration platform, the resource viewing operation is used to view information of a proxy service, and business data between the integration platform and a device on which the proxy service is installed is transmitted through the proxy service; and

in response to the resource viewing operation, displaying a resource topology, the resource topology is used to indicate an association relationship between at least one proxy service and at least one device.

In a second aspect, an embodiment of the present application provides an information processing method which is applied to a target application program installed on a first device, comprising:

receiving operation and maintenance data sent by an integration platform; and

executing an operation related to a target proxy service according to the operation and maintenance data, business data between the integration platform and the first device is transmitted through a first proxy service installed on the first device.

In a third aspect, an embodiment of the present application provides an information processing apparatus which is applied to an integration platform, comprising:

a receiving unit, configured to receive a resource viewing operation triggered in the integration platform, the resource viewing operation is used to view information of a proxy service, and business data between the integration platform and a device on which the proxy service is installed is transmitted through the proxy service; and

a first display unit, configured to, in response to the resource viewing operation, displaying a resource topology, the resource topology indicating an association relationship between at least one proxy service and at least one device.

In a forth aspect, an embodiment of the present application provides an information processing apparatus which is applied to a target application program installed on a first device, comprising:

a receiving unit, configured to receive operation and maintenance data sent by an integration platform; and

an execution unit, configured to execute an operation related to a target proxy service according to the operation and maintenance data, business data between the integration platform and the first device is transmitted through a first proxy service installed on the first device.

In a fifth aspect, an embodiment of the application provides a device, wherein the device comprises a processor and a memory,

the processor is used for executing instructions stored in the memory to cause the device to perform the method described in any one of the first aspect above, or to cause the device to perform the method described in any one of the second aspect above.

In a sixth aspect, an embodiment of the present application provides a computer-readable storage medium, comprising instructions that instruct a device to perform the method described in any one of the first aspect above, or that instruct the device to perform the method described in any one of the second aspect above.

In a seventh aspect, an embodiment of the present application provides a computer program product, when the computer program product is run on a computer, causing the computer to perform the method described in any one of the first aspect above, or causing the computer to perform the method described in any one of the second aspect above.

Compared with the prior art, embodiments of the present application have the following advantages.

An embodiment of the present application provides an information processing method which can be applied to an integration platform. The integration platform can receive a resource viewing operation triggered in the integration platform, the resource viewing operation is used to view the information of a proxy service, and business data between the integration platform and a device on which the proxy service is installed are transmitted through the proxy service. After the resource viewing operation is received, a resource topology can be displayed in response to the resource viewing operation, and the resource topology indicates an association relationship between at least one proxy service and at least one device. Thus, by using this scheme, users can view the resource topology after triggering the resource viewing operation, so as to obtain the association relationship between the proxy service and the device. This significantly enhance the efficiency of obtaining the association relationship for users, thereby improving the efficiency of proxy service management.

An embodiment of the present application further provides an information processing method which can be applied to a target application program installed on a first device. The target application program can receive operation and maintenance data sent by an integration platform, and execute an operation related to a proxy service according to the operation and maintenance data. Business data between the integration platform and the first device are transmitted through a first proxy service installed on the first device. It can be seen that, in the embodiment of the present application, when the integration platform interacts with the first device, the business data are transmitted through the first proxy service installed on the first device. The operation and maintenance data between the integration platform and the first proxy service are transmitted through the target application program installed on the first device, instead of both operation and maintenance data transmission and business data being transmitted through the first agent service. This realizes the decoupling of business data and operation and maintenance data, and improves the efficiency of proxy service management.

### BRIEF DESCRIPTION OF THE DRAWINGS

In order to clearly explain the embodiments of the present application or the technical scheme in the prior art, the drawings needed in the description of the embodiments or the prior art will be briefly introduced below. Obviously, the drawings in the following description are only some of the embodiments recorded in the present application, and other drawings can be obtained according to these drawings without creative work for ordinary people in the art.

FIG. 1 is a flowchart of an information processing method according to an embodiment of the present application;

FIG. 2a is a diagram of a page corresponding to an integration platform according to an embodiment of the present application;

FIG. 2b a diagram of another page corresponding to an integration platform according to an embodiment of the present application;

FIG. 2c is a diagram of a first page according to an embodiment of the present application;

FIG. 2d is a diagram of a second page according to an embodiment of the present application;

FIG. 3 is a flowchart of another information processing method according to an embodiment of the present application;

FIG. 4 is a structural diagram of an information processing apparatus according to an embodiment of the present application; and

FIG. 5 is a structural diagram of another information processing apparatus according to an embodiment of the present application.

### DETAILED DESCRIPTION

In order to make those skilled in the art better understand the scheme of the application, the technical scheme in the embodiment of the present application will be described clearly and completely with the attached drawings. Obviously, the described embodiment is only a part of the embodiment of the present application, but not the whole embodiment. Based on the embodiments in the present application, all other embodiments obtained by ordinary technicial person in the art without creative work belong to the protection scope of this application.

Users can access data from other devices through an integration platform. Regarding the integration platform, it should be noted that:

The integration platform combines an integration of application systems with an integration architecture, and solves the problems of high integration cost and low efficiency of enterprises through low construction cost and high integration ability. In this embodiment, the integration platform can integrate multiple systems corresponding to the enterprise and provides a unified operation portal, enabling users to perform corresponding operations without individually accessing each system, resulting in improved efficiency in business processing.

In one example, the integration platform can be deployed in an external network, and users can access the data of a device deployed in an internal network through the integration platform. In this case, a proxy service can be installed on the device located in the internal network, which serve as an intermediary for the integration platform to interact with the device in the internal network. The proxy service mentioned in this embodiment of the present application may be an application program. As an example, when the integration platform and the device in the internal network support different data protocols, the proxy service can convert the data from the integration platform into first data conforming to the data protocol supported by the device in the internal network, and send the first data to the device. Correspondingly, the proxy service can also convert the data from the device into second data conforming to the data protocol supported by the integration platform, and send the second data to the integration platform.

On one hand, for numerous devices, if it is need to determine which proxy services are installed on these devices, users can determine which proxy services are installed on each device one by one, which is inefficient and leads to low efficiency of proxy services management.

On the other hand, data transmitted between the integration platform and the proxy service comprise both business data and operation and maintenance data. For example, the integration platform can send an operation and maintenance instruction to the proxy service, the proxy service can report its own operating status to the integration platform, and so on.

Due to the inclusion of both business data and operation and maintenance data in the data transmitted between the integration platform and the proxy service, in case of a proxy service failure, the transmission of both business data and operation and maintenance data between the integration platform and the proxy service would be interrupted, which is disadvantageous for managing the proxy services by the integration platform, and leads to low management efficiency of the proxy services.

In order to solve the above problems, embodiments of the present application provide an information processing method and apparatus.

Various non-limiting embodiments of the present application will be described in detail with reference to the accompanying drawings.

### Exemplary Method

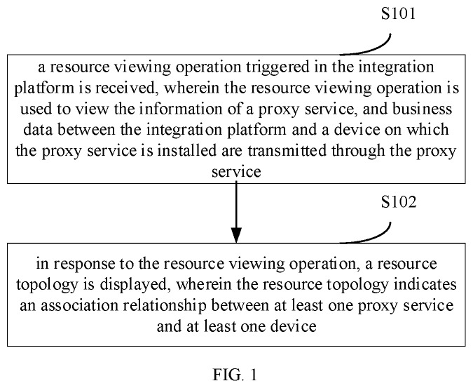

Please refer to FIG. 1, which is a flowchart of an information processing method according to an embodiment of the present application. The method shown in FIG. 1 can be applied to an integration platform. In one example, the method may comprise the following steps S101-S102.

In S101, a resource viewing operation triggered in the integration platform is received, wherein the resource viewing operation is used to view the information of a proxy service, and business data between the integration platform and a device on which the proxy service is installed are transmitted through the proxy service.

In one example, the integration platform can be deployed in an external network, and the proxy service can be deployed in an internal network. In this case, business data between the integration platform deployed in the external network and the device deployed in the internal network can be transmitted through the proxy service. In this way, users can access the data of the device in the internal network through the integration platform deployed in the external network.

In one example, users can trigger a resource viewing operation in a page corresponding to the integration platform. As an example, the page corresponding to the integration platform can comprise a resource viewing control, and users can trigger the resource viewing operation through the resource viewing control. For example, users can trigger the resource viewing operation by clicking the resource viewing control. Accordingly, the integration platform can receive the resource viewing operation.

In this embodiment of the present application, the resource viewing operation is used to view the information of the proxy service. With regard to the proxy service, please refer to the previous related descriptions, which will not be repeated here. It should be mentioned here that, in the embodiment of the present application, the business data between the integration platform and the device on which the proxy service is installed are transmitted through the proxy service. Operation and maintenance data are no longer transmitted between the integration platform and the proxy service.

In this embodiment of the present application, the business data may be business-related data, and the specific content of the business data may be related to specific business, which is not limited here.

In S102, in response to the resource viewing operation, a resource topology is displayed, wherein the resource topology indicates an association relationship between at least one proxy service and at least one device.

After receiving the resource viewing operation, the integration platform can display a resource topology in response to the resource viewing operation. The resource topology indicates an association relationship between at least one proxy service and at least one device.

In one example, the resource topology may comprise at least one proxy service and at least one device, and the association relationship between the proxy service and the at least one device may be represented by a connecting line between the proxy service and the device, for example. As an example, if the resource topology comprises proxy service A and device A, and there is a connecting line between the device A and the proxy resource A, it means that the proxy service A is installed on the device A.

In another example, the resource topology may further comprise an integration platform. In this case, the association relationship between the at least one proxy service and the at least one device may comprise an association relationship between the at least one proxy service and the integration platform, and an association relationship between the integration platform and the at least one device. In this case, based on the resource topology, it is possible to determine the association relationship between the device and the proxy service, as well as determine the role played by the integration platform between the device and the proxy service, that is, determine that the integration platform can communicate with the device through the proxy service. In a specific example, the resource topology represents a connection relationship between the proxy service and the integration platform and a connection relationship between the integration platform and the device.

In another example, proxy services can be divided into clusters, and one proxy service cluster comprises several proxy services. Correspondingly, the association relationship between the at least one proxy service and the at least one device may comprise an association relationship between at least one proxy service cluster and the at least one device. By adopting this approach, the structure of the resource topology becomes clearer compared to individually displaying each proxy service.

In order to improve the efficiency of proxy service management, the resource topology can also support interactive operations. Next, the interactive operations supported by the resource topology are introduced.

In one implementation, the aforementioned at least one proxy service cluster may comprise a first cluster. Users can trigger a first operation for the first cluster. In this embodiment of the present application, triggering the first operation for the first cluster may be triggering the first operation for a cluster identifier of the first cluster in the resource topology. The first operation mentioned here may be a click operation, for example. After users trigger the first operation for the first cluster, the integration platform can display the information of proxy services in the first cluster in response to the first operation, so that users can determine the information of proxy services in the first cluster, thereby improving the efficiency of proxy service management.

In one example, the integration platform can display the information of the proxy services in the first cluster in the form of a pop-up. In another example, the integration platform can display a first page, and display the information of the proxy services in the first cluster in the first page.

As an example, the integration platform can, for example, display the information of the proxy services in the first cluster in the form of a list, and each entry in the list corresponds to information of one proxy service.

In this embodiment of the present application, the information of the proxy service may comprise an identifier of the proxy service, and may also comprise an identifier of the device on which the proxy service is installed, a state of the proxy service, creation time of the proxy service, etc., which is not limited by the embodiment of the present application. The identifier of the proxy service may comprise, for example, an icon of the proxy service and a name of the proxy service, and the identifier of the device may comprise, for example, a name of the device.

As yet another example, the integration platform can also display the statistical information of the proxy services in the first cluster, for example, it can display the number of proxy service(s) in an online state in the first cluster, the number of proxy service(s) in an offline state in the first cluster, and so on.

In one example, users can also trigger a proxy service adding operation in the first page. For example, the first page can comprise a first proxy service adding control, and users can trigger the proxy service adding operation through the first proxy service adding control. After the proxy service adding operation is triggered by users in the first page, the integration platform can add a first proxy service to the first cluster in response to the proxy service adding operation. As a specific example, the integration platform can display a proxy service adding interface in response to the proxy service adding operation, and in the proxy service adding interface, users can input the information of the first proxy service and further trigger an adding confirmation operation. Accordingly, the integration platform can obtain the information of the first proxy service in response to the adding confirmation operation, and add the first proxy service to the first cluster according to the information of the first proxy service. In this way, users can directly perform corresponding operations in the first page, so as to add the first proxy service to the first cluster, resulting in high efficiency of proxy service management.

In yet another implementation, the at least one device may comprise a first device. Users can trigger a second operation for the first device. In this embodiment of the present application, triggering the second operation for the first device may be triggering the second operation for a device identifier of the first device in the resource topology. The second operation mentioned here may be a click operation, for example. After users trigger the second operation for the first device, the integration platform can display the information of proxy services installed on the first device in response to the second operation, so that users can determine the information of the proxy service(s) installed on the first device, thereby improving the efficiency of proxy service management.

In one example, the integration platform can display the information of the proxy services installed on the first device in the form of a pop-up. In another example, the integration platform can display a second page, and display the information of the proxy service(s) installed on the first device in the second page.

As an example, the integration platform can, for example, display the information of the proxy service(s) installed on the first device in the form of a list, and each entry in the list corresponds to the information of one proxy service.

As to the information of the proxy service(s), please refer to the previous related descriptions, which will not be repeated here.

In one example, users can also trigger a proxy service adding operation in the second page. For example, the second page can comprise a second proxy service adding control, and users can trigger the proxy service adding operation through the second proxy service adding control. After the proxy service adding operation is triggered by users in the second page, the integration platform can install a second proxy service on the first device in response to the proxy service adding operation. In this way, users can directly perform corresponding operations in the second page, so as to install the second proxy service on the first device, resulting in high efficiency of proxy service management.

As an example, the integration platform can install a second proxy service on the first device through a third-party device.

As mentioned above, in the embodiment of the present application, the operation and maintenance data are no longer transmitted between the proxy service and the integration platform. In one example, a target application program is installed on the first device, and operation and maintenance data between the integration platform and the proxy service(s) installed on the first device are transmitted through the target application program. In this way, even if the proxy service(s) installed on the first device fails, the integration platform can still transmit the operation and maintenance data to the target application program, so as to manage the proxy service(s) installed on the first device through the target application program. In this case, as an example, the integration platform can install a second proxy service on the first device through the target application program.

In one example, the integration platform can send a proxy service installation instruction to the target application program, and after receiving the instruction, the target application program can install a second proxy service on the first device based on the instruction.

In yet another example, installing the second proxy service on the first device through the target application program may specifically comprise the following steps A1-A3.

In A1, proxy service configuration information is acquired.

As a specific example, the integration platform can display a proxy service configuration interface in response to the proxy service adding operation triggered in the second page, and users can input the proxy service configuration information in the proxy service configuration interface and further trigger an installation confirmation operation, for example, by an installation confirmation control. Accordingly, the integration platform can obtain the proxy service configuration information in response to the installation confirmation operation.

In the embodiment of the present application, the proxy service configuration information may be the configuration information of the second proxy service to be installed, and the proxy service configuration information includes, but is not limited to, a name of the proxy service, a name of an interface through which the proxy service interacts with the first device, and an operating system on which the proxy service runs, etc.

In A2, the proxy service configuration information is sent to the target application program.

In A3, a proxy service installation command is sent, by the target application program, to the first device based on the proxy service information, wherein the proxy service installation command is used to instruct the first device to install the second proxy service.

After obtaining the proxy service configuration information, the integration platform can send the proxy service configuration information to the target application program, so that the target application program can install the second proxy service on the first device based on the proxy service configuration information.

In one example, after receiving the proxy service configuration information, the target application program can generate a proxy service installation command based on the proxy service configuration information, and the proxy service installation command is used to instruct the first device to install the second proxy service. After generating the proxy service installation command, the target application program can send the proxy service installation command to the first device, and correspondingly, the first device can install the second proxy service upon receiving the proxy service installation command.

In one example, the proxy service installation command may contain the aforementioned proxy service configuration information, and accordingly, the first device can obtain a proxy service installation file matching the proxy service configuration information from a server based on the proxy service configuration information, and install the installation file, so as to install the second proxy service.

In another example, the proxy service installation command may contain a download address of the installation file of the second proxy service, and the target application program may, for example, parse the proxy service configuration information to determine the download address of the installation file of the second proxy service corresponding to the proxy service configuration information. Accordingly, the first device can download the proxy service installation file matching the proxy service configuration information based on the installation file download address, and install the installation file, so as to install the second proxy service.

In another implementation, the at least one proxy service comprises a third proxy service, and users can trigger a third operation for the third proxy service. For example, a hovering operation can be triggered for the third proxy service. Accordingly, the integration platform can change a display pattern of an association relationship between the third proxy service and a target device in response to the third operation, so that users can intuitively determine that the third proxy service has an association relationship with the target device from the whole resource topology. For example, a connecting line representing the association relationship between the third proxy service and the target device is displayed in bold. As another example, the color of the connecting line representing the association relationship between the third proxy service and the target device is changed.

In another implementation, the at least one device comprises a second device, and users can trigger a fourth operation for the second device. For example, a hovering operation can be triggered for the second device. Accordingly, the integration platform can change a display pattern of an association relationship between the second device and a target proxy service in response to the fourth operation, so that users can intuitively determine that the second device has an association relationship with the target proxy service from the whole resource topology. For example, a connecting line representing the association relationship between the second device and the target proxy service is displayed in bold. As another example, the color of the connecting line representing the association relationship between the second device and the target proxy service is changed.

Next, the scheme provided by the above embodiment will be introduced with reference to the attached drawings.

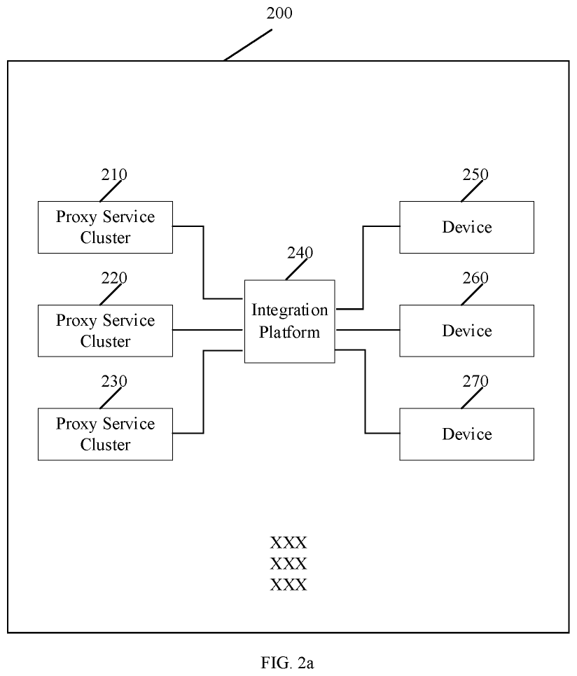

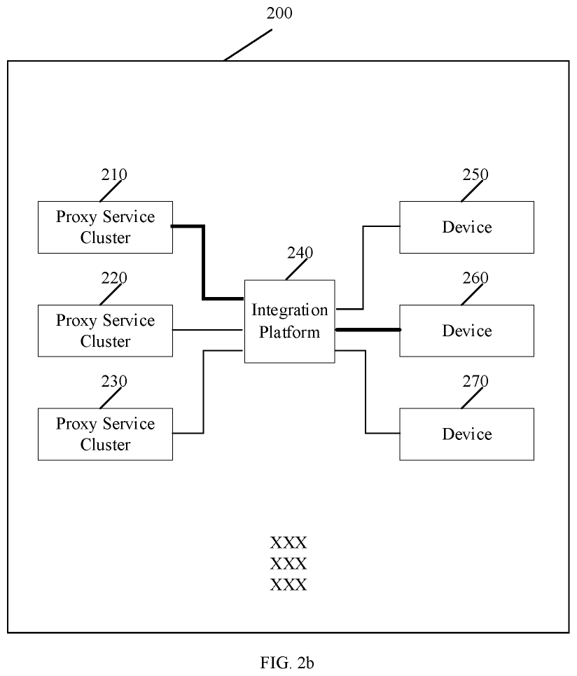

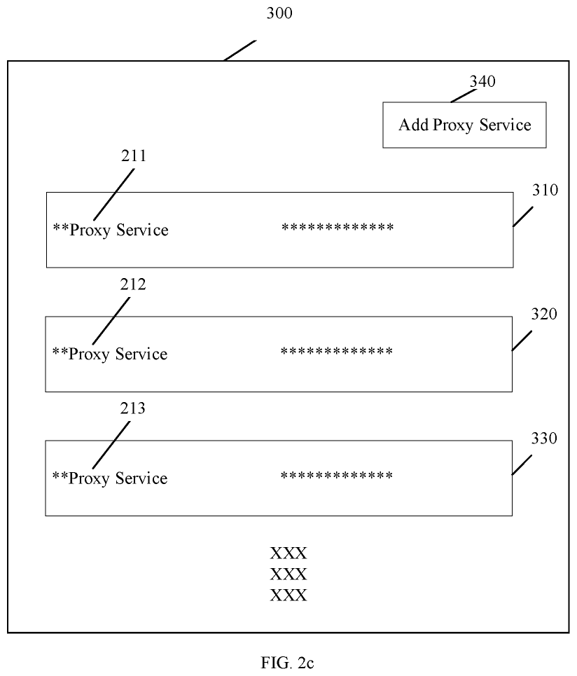

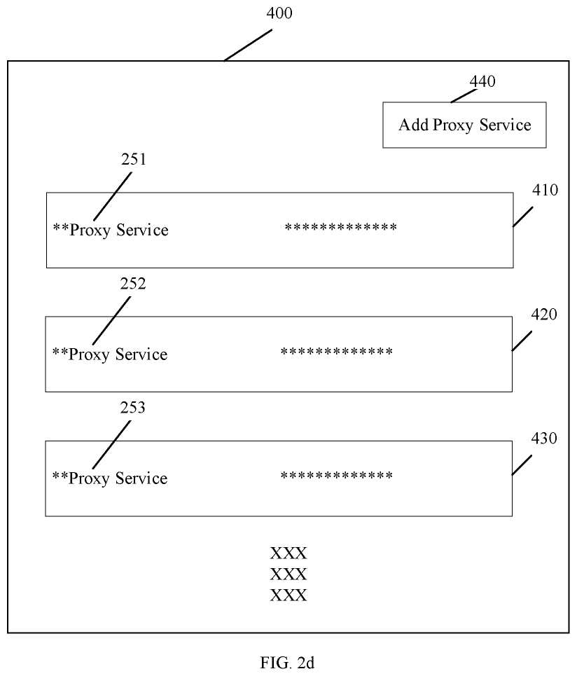

Please refer to FIG. 2a, which is a diagram of a page corresponding an integration platform according to an embodiment of the present application. As shown in FIG. 2a, a resource topology is displayed in a page 200, and the resource topology comprises three proxy service clusters, namely, proxy service cluster 210, proxy service cluster 220 and proxy service cluster 230, which also comprises an integration platform 240 and identifiers of three devices, namely, device 250, device 260 and device 270. Each proxy service cluster is connected to the integration platform 240, and each device is also connected to the integration platform 240.

In an example, after users trigger a hovering operation for the proxy service cluster 210, the content displayed on the page 200 is as shown in FIG. 2b, which is a diagram of another page corresponding to an integration platform according to an embodiment of the present application. As shown in FIG. 2b, a connecting line between the proxy service cluster 210 and the integration platform 240 is bold, and a connecting line between the integration platform 240 and the device 260 is bold. According to this page 200, users can determine that at least one proxy service in the proxy service cluster 210 is installed in the device 260.

In another example, after users trigger a hovering operation for the device 260, the content displayed on the page 200 is as shown in FIG. 2b. According to this page 200, users can determine that at least one proxy service in the proxy service cluster 210 is installed in the device 260. In another example, after users trigger a click operation for the proxy service cluster 210, the integration platform can display a first page 300 shown in FIG. 2c. The information of three proxy services (proxy service 211, proxy service 212 and proxy service 213) in the proxy service cluster 210 is displayed in the first page 300, wherein an area 310 in the first page 300 displays the information of the proxy service 211, an area 320 in the first page 300 displays the information of the proxy service 212, and an area 330 in the first page 300 displays the information of the proxy service 213. In FIG. 2c, the information of each proxy service is represented by “***”. In addition, the first page 300 also comprises a first proxy service adding control 340, through which users can trigger a proxy service adding operation, thereby adding a new proxy service to the proxy service cluster 210. In yet another example, after users trigger a click operation for the device 250, the integration platform can display a second page 400 shown in FIG. 2d. The information of three proxy services (proxy service 251, proxy service 252 and proxy service 253) installed on the device 250 is displayed in the second page 400, wherein an area 410 in the second page 400 displays the information of the proxy service 251, an area 420 in the second page 400 displays the information of the proxy service 252, and an area 430 in the second page 400 displays the information of the proxy service 253. In FIG. 2d, the information of each proxy service is represented by “***”. In addition, the second page 400 also comprises a second proxy service adding control 440, through which users can trigger a proxy service adding operation, thereby installing a new proxy service on the device 250.

With regard to FIGS. 2a-2d, it should be noted that they are only shown for the convenience of understanding the scheme, and they do not constitute a limitation on the embodiment of the present application. Other contents can also be included in the pages shown in FIGS. 2a-2d, which are indicated by “XXX” in FIGS. 2a-2d.

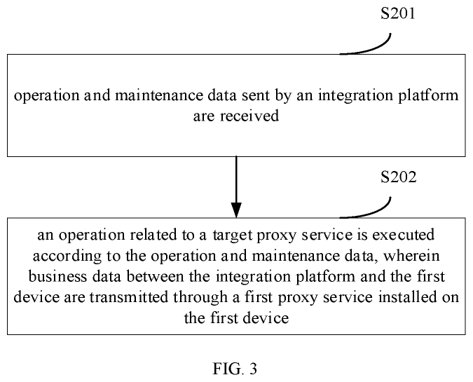

An embodiment of the present application also provides an information processing method, as shown in FIG. 3, which is a flowchart of another information processing method according to an embodiment of the present application. The information processing method shown in FIG. 3 can be applied to a target application program installed on a first device. As mentioned above, the operation and maintenance data between the integration platform and the proxy service installed on the first device can be transmitted through the target application program.

Next, the information processing method executed by the target application program is introduced.

The method shown in FIG. 3 may comprise the following steps S201-S202.

In S201, operation and maintenance data sent by an integration platform are received.

In S202, an operation related to a target proxy service is executed according to the operation and maintenance data, wherein business data between the integration platform and the first device are transmitted through a first proxy service installed on the first device.

The integration platform can send the operation and maintenance data to the target application program, and accordingly, the target application program can receive the operation and maintenance data sent by the integration platform. After receiving the operation and maintenance data, the target application program can perform a corresponding processing operation based on the operation and maintenance data. Specifically, an operation related to the target proxy service can be performed.

In one example, the target proxy service may be a first proxy service installed on the first device. In this case:

In a specific example, the operation related to the target proxy may be controlling the first proxy service to restart or stop running. As an example, the target application program can send a control instruction to the first proxy service, and the control instruction instructs the first proxy service to restart or stop running, so as to achieve the purpose of controlling the first proxy service to restart or stop running. For example, the target application program can send a restart instruction to the first proxy service, thereby controlling the first proxy service to restart. The target application program can send a stop instruction to the first proxy service, thereby controlling the first proxy service to stop running. In one example, the integration platform can control the first proxy service to restart or stop running through the target application program when the first proxy service is running abnormally, thus effectively managing the first proxy service.

In one example, the target application program can also acquire a working state of the first proxy service and send the working state to the integration platform. Accordingly, the integration platform can save the working state of the first proxy service. In some scenarios, the integration platform can also display the working state of the first proxy service, for example, display the working state of the first proxy service in the forementioned first page or the forementioned second page.

As an example, the target application program can determine the working state of the first proxy service by acquiring a state of an interface related to the first proxy service. For example, if the interface is in a working state, it can be determined that the working state of the first proxy service is online, and if the interface is in a non-working state, it can be determined that the working state of the first proxy service is offline.

As an example, the target application program can send the working state to the integration platform by sending a heartbeat to the integration platform. This heartbeat can be understood as a message sent by the target application program to the integration platform. The heartbeat can contain the working state of the first proxy service.

In yet another example, the target proxy service may be a second proxy service to be installed. In this case, the operation related to the target proxy may be installing the second proxy service on the first device. In this way, the integration platform can automatically install the second proxy service on the first device through the target application program, which improves the efficiency of installing proxy services on the device.

For the specific implementation of installing the second proxy service on the first device through the target application program, please refer to the relevant descriptions in the previous text, which will not be repeated here.

For the related contents of the integration platform and the proxy service, please refer to the relevant descriptions of the above embodiments, which will not be repeated here.

From the above descriptions, it can be seen that in this embodiment of the present application, when the integration platform interacts with the first device, the business data are transmitted through the first proxy service installed on the first device. The operation and maintenance data between the integration platform and the first proxy service are transmitted through the target application program installed on the first device, instead of relying solely on the first proxy service for both operation and maintenance data transmission and business data transmission. This realizes the decoupling of business data and operation and maintenance data, and effectively improves the efficiency of proxy service management.

In the embodiments of the present application, the information processing method shown in FIG. 1 and the information processing method shown in FIG. 3 can be combined or cross-referenced without conflict.

### Exemplary Device

Based on the method provided in the above embodiment, an embodiment of the present application provides an apparatus, which will be introduced below with reference to the attached drawings.

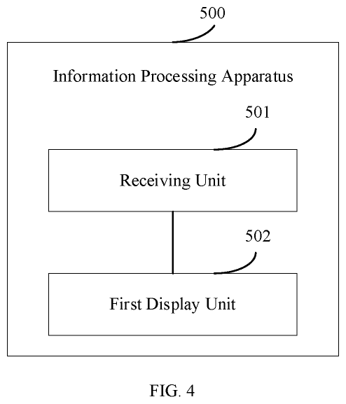

Please refer to FIG. 4, which is a structural diagram of an information processing apparatus according to an embodiment of the present application. The information processing apparatus 500 shown in FIG. 4 can be applied to an integration platform. The apparatus 500 comprises a receiving unit 501 and a first display unit 502.

The receiving unit 501 is used for receiving a resource viewing operation triggered in the integration platform, the resource viewing operation is used to view the information of a proxy service, and business data between the integration platform and a device on which the proxy service is installed being transmitted through the proxy service.

The first display unit 502 is used for, in response to the resource viewing operation, displaying a resource topology, the resource topology indicating an association relationship between at least one proxy service and at least one device.

Alternatively, the association relationship between the at least one proxy service and the at least one device comprises:

an association relationship between the at least one proxy service and the integration platform, and an association relationship between the integration platform and the at least one device.

Alternatively, the association relationship between the at least one proxy service and the at least one device comprises:

an association relationship between at least one proxy service cluster and the at least one device, each proxy service cluster comprising several proxy services.

Alternatively, the at least one proxy service cluster comprises a first cluster, and the apparatus further comprises:

a second display unit used for, in response to a first operation triggered for the first cluster, displaying the information of proxy services in the first cluster.

Alternatively, the second display unit is used for:

displaying the information of the proxy services in the first cluster in a first page; and

the apparatus further comprises:

an adding unit used for, in response to a proxy service adding operation triggered in the first page, adding a first proxy service to the first cluster.

Alternatively, the at least one device comprises a first device, and the apparatus further comprises:

a third display unit used for, in response to a second operation triggered for the first device, displaying the information of a proxy service installed on the first device.

Alternatively, the third display unit is used for:

displaying the information of the proxy service installed on the first device in a second page; and the apparatus further comprises:

an installation unit used for, in response to a proxy service adding operation triggered in the second page, installing a second proxy service on the first device.

Alternatively, a target application program is installed on the first device, operation and maintenance data between the integration platform and the proxy service installed on the first device are transmitted through the target application program, and the installation unit is used for:

installing the second proxy service on the first device by means of the target application program.

Alternatively, the installation unit is used for:

acquiring proxy service configuration information;

sending the proxy service configuration information to the target application program; and

sending a proxy service installation command, by the target application program, to the first device based on the proxy service information, the proxy service installation command instructing the first device to install the second proxy service.

Alternatively, the at least one proxy service comprises a third proxy service, and the apparatus further comprises:

a first change unit used for, in response to a third operation triggered for the third proxy service, changing a display pattern of an association relationship between the third proxy service and a target device, the target device being a device having an association relationship with the third proxy service.

Alternatively, the at least one device comprises a second device, and the apparatus further comprises:

a second change unit used for, in response to a fourth operation triggered for the second device, changing a display pattern of an association relationship between the second device and a target proxy service, the target proxy service being a device having an association relationship with the second device.

Alternatively, the integration platform is deployed in an external network and the proxy service is deployed in an internal network.

As the apparatus 500 is an apparatus corresponding to the information processing method executed by the integration platform provided by the above method embodiment, the specific implementation of each unit of the apparatus 500 is based on the same concept as the above method embodiment. Therefore, for the specific implementation of each unit of the apparatus 500, reference can be made to the relevant descriptions of the above method embodiment, which will not be repeated here.

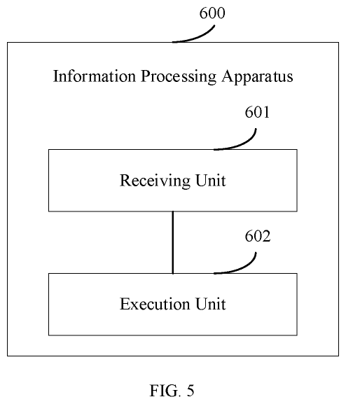

Please refer to FIG. 5, which is a structural diagram of another information processing apparatus according to an embodiment of the present application. The information processing apparatus 600 shown in FIG. 5 can be applied to a target application program installed on a first device, and comprises a receiving unit 601 and an execution unit 602.

The receiving unit 601 is used for receiving operation and maintenance data sent by an integration platform.

The execution unit 602 is used for executing an operation related to a target proxy service according to the operation and maintenance data, business data between the integration platform and the first device being transmitted through a first proxy service installed on the first device.

Alternatively, the execution unit 602 is used for:

controlling the first proxy service to restart or stop running.

Alternatively, the execution unit 602 is used for:

sending a control instruction to the first proxy service, the control instruction instructing the first proxy service to restart or stop running.

Alternatively, the execution unit 602 is used for:

installing a second proxy service on the first device.

Alternatively, the execution unit 602 is used for:

sending a proxy service installation command to the first device, the proxy service installation command instructing the first device to install the second proxy service.

Alternatively, the apparatus further comprises:

an acquisition unit used for acquiring a working state of the first proxy service; and

a sending unit used for sending the working state to the integration platform.

Alternatively, a resource topology is displayed in the integration platform, the resource topology indicates an association relationship between at least one proxy service and at least one device, the resource topology is displayed by the integration platform in response to a resource viewing operation, and t the resource viewing operation is used to view the information of a proxy service.

Alternatively, the association relationship between the at least one proxy service and the at least one device comprises:

an association relationship between the at least one proxy service and the integration platform, and an association relationship between the integration platform and the at least one device.

Alternatively, the association relationship between the at least one proxy service and the at least one device comprises:

an association relationship between at least one proxy service cluster and the at least one device, each proxy service cluster comprising several proxy services.

Alternatively, the integration platform is deployed in an external network and the target proxy service is deployed in an internal network.

As the apparatus 600 is an apparatus corresponding to the information processing method executed by the target application program provided by the above method embodiment, the specific implementation of each unit of the apparatus 600 is based on the same concept as the above method embodiment. Therefore, for the specific implementation of each unit of the apparatus 600, reference can be made to the relevant descriptions of the above method embodiment, which will not be repeated here.

An embodiment of the present application also provides a device, which comprises a processor and a memory.

The processor is used for executing instructions stored in the memory to enable the device to perform the information processing method described in any one of the above method embodiments.

An embodiment of the present application also provides a computer-readable storage medium, which comprises instructions that instruct a device to perform the information processing method described in any one of the above method embodiments.

An embodiment of the present application further provides a computer program product, and when the computer program product is run on a computer, the computer performs the information processing method described in any one of the above method embodiments.

Other embodiments of the present application will easily occur to those skilled in the art after considering the specification and practicing the invention disclosed herein. The present application is intended to cover any variations, uses or adaptations of the present application, which follow the general principles of this application and include common sense or common technical means in this technical field that are not disclosed in this disclosure. The specification and embodiments are to be regarded as exemplary only, with the true scope and spirit of the application indicated by the appended claims.

It should be understood that this application is not limited to the precise structure described above and shown in the drawings, and various modifications and changes can be made without departing from its scope. The scope of this application is limited only by the appended claims.

The above is only the preferred embodiment of this application, and it is not used to limit this application. Any modification, equivalent substitution, improvement, etc. made within the spirit and principle of this application should be included in the protection scope of this application.

1. An information processing method which is applied to an integration platform, comprising:
receiving a resource viewing operation triggered in the integration platform, the resource viewing operation is used to view information of a proxy service, and business data between the integration platform and a device on which the proxy service is installed is transmitted through the proxy service; and
in response to the resource viewing operation, displaying a resource topology, the resource topology is used to indicate an association relationship between at least one proxy service and at least one device.

2. The method according to claim 1, wherein the association relationship between the at least one proxy service and the at least one device comprises:
an association relationship between the at least one proxy service and the integration platform, and an association relationship between the integration platform and the at least one device.

3. The method according to claim 1, wherein the association relationship between the at least one proxy service and the at least one device comprises:
an association relationship between at least one proxy service cluster and the at least one device, each proxy service cluster comprising several proxy services.

4. The method according to claim 3, wherein the at least one proxy service cluster comprises a first cluster, and the method further comprises:
in response to a first operation triggered for the first cluster, displaying the information of the proxy services comprised in the first cluster.

5. The method according to claim 4, wherein displaying the information of the proxy services comprised in the first cluster, comprising:
displaying the information of the proxy services comprised in the first cluster in a first page; and
the method further comprises:
in response to a proxy service adding operation triggered in the first page, adding a first proxy service to the first cluster.

6. The method according to claim 1, wherein the at least one device comprises a first device, and the method further comprises:
in response to a second operation triggered for the first device, displaying the information of a proxy service installed on the first device.

7. The method according to claim 6, wherein displaying the information of the proxy service installed on the first device comprises:
displaying the information of the proxy service installed on the first device in a second page; and the method further comprises:
in response to a proxy service adding operation triggered in the second page, installing a second proxy service on the first device.

8. The method according to claim 7, wherein a target application program is installed on the first device, operation and maintenance data between the integration platform and the proxy service installed on the first device are transmitted through the target application program, and installing the second proxy service on the first device comprises:
installing the second proxy service on the first device by means of the target application program.

9. The method according to claim 8, wherein installing the second proxy service on the first device by means of the target application program, comprising:
acquiring proxy service configuration information;
sending the proxy service configuration information to the target application program; and
sending a proxy service installation command, by the target application program, to the first device based on the proxy service information, the proxy service installation command is used to instruct the first device to install the second proxy service.

10. The method according to claim 1, wherein the at least one proxy service comprises a third proxy service, and the method further comprises:
in response to a third operation triggered for the third proxy service, changing a display pattern of an association relationship between the third proxy service and a target device, the target device is a device having an association relationship with the third proxy service.

11. The method according to claim 1, wherein the at least one device comprises a second device, and the method further comprises:
in response to a fourth operation triggered for the second device, changing a display pattern of an association relationship between the second device and a target proxy service, the target proxy service is a device having an association relationship with the second device.

12. The method according to claim 1, wherein the integration platform is deployed in an external network and the proxy service is deployed in an internal network.

13. An information processing method which is applied to a target application program installed on a first device, comprising:
receiving operation and maintenance data sent by an integration platform; and
executing an operation related to a target proxy service according to the operation and maintenance data, business data between the integration platform and the first device is transmitted through a first proxy service installed on the first device.

14. The method according to claim 13, wherein executing an operation related to a target proxy service according to the operation and maintenance data, comprising:
controlling the first proxy service to restart or stop running.

15. The method according to claim 14, wherein controlling the first proxy service to restart or stop running, comprising:
sending a control instruction to the first proxy service, the control instruction is used to instruct the first proxy service to restart or stop running.

16. The method according to claim 13, wherein executing an operation related to a target proxy service according to the operation and maintenance data comprises:
installing a second proxy service on the first device.

17. The method according to claim 16, wherein installing the second proxy service on the first device, comprising:
sending a proxy service installation command to the first device, the proxy service installation command is used to instruct the first device to install the second proxy service.

18. The method according to claim 13, further comprising:
acquiring a working state of the first proxy service; and
sending the working state to the integration platform.

19. A device, wherein the device comprises a processor and a memory,
the processor is used for executing instructions stored in the memory to enable the device to perform the method according to claim 1.

20. A non-transitory computer-readable storage medium, comprising instructions that instruct a device to perform the method according to claim 1.
